(19) United States
(12) Patent Application Publication
(10) Pub. No.: US 2014/0194103 A1
(43) Pub. Date: Jul. 10, 2014

(54) SOFTMODEM ACTIVATION AND CUSTOMIZATION

(71) Applicants: Murt O'Donnell, Waltham, MA (US); Ramana Dommata, Waltham, MA (US)

(72) Inventors: Murt O'Donnell, Waltham, MA (US); Ramana Dommata, Waltham, MA (US)

(21) Appl. No.: 13/796,617

(22) Filed: Mar. 12, 2013

Related U.S. Application Data
(60) Provisional application No. 61/750,595, filed on Jan. 9, 2013.

(51) Int. Cl. H04W 8/22

(52) U.S. Cl. CPC H04W 8/22
USPC 455/418

(57) ABSTRACT

Systems and methods are provided for activating, configuring, and/or re-configuring a “softmodem” in a computer device. The softmodem can be specially configured to accept firmware specifications that control the operation of communication by the softmodem. According to one embodiment, in conjunction with a firmware download and installation, at activation an unlocking key can be provided to enable, for example, data service through any selected provider using the softmodem. In some embodiments, the softmodem is specially configured to accommodate a variety of data signal protocols (e.g., CDMA, GSM, etc.) through firmware downloads and configuration. Installation of the firmware on the softmodem enables the softmodem to communicate according to a selected communication protocol and further enables re-configuration of the softmodem between the variety of data signal protocols.

### RELATED APPLICATIONS

This application claims priority under 35 U.S.C. §119(e) to U.S. Provisional Application Ser. No. 61/750,595 entitled “SOFTMODEM ACTIVATION AND CUSTOMIZATION,” filed Jan. 1, 2013, which application is herein incorporated by reference in its entirety.

### BACKGROUND

Current tablet computing and mobile computing needs have grown exponentially, as typical consumers desire smaller and easier to use mobile computing devices. To fully utilize such mobile devices, data service, oftentimes in the form of data plan serviced by a cellular provider, is required. The data service enables wireless connectivity for the mobile device through a data service provider. In some conventional devices, the hardware configured in the device is specifically configured for the communication architecture employed by the data service provider.

### SUMMARY

According to one aspect, a “softmodem” is provided in a tablet computer or other mobile computing system. The softmodem is specially configured to accept firmware specifications that control the operation of communication by the softmodem. According to one embodiment, in conjunction with the firmware download and installation, at activation an unlocking key can be provided to enable, for example, data service through any selected provider using the softmodem. In some embodiments, the softmodem is specially configured to accommodate a variety of data signal protocols (e.g., CDMA, GSM, etc.) through firmware downloads and configuration. Installation of the firmware on the softmodem enables the softmodem to communicate according to a selected communication protocol.

According to another aspect, devices incorporating softmodem technology can be utilized to implement post distribution configuration and data plan activation of mobile computing devices. In some embodiments, the post distribution configuration and activation can be executed for any provider regardless of the signaling technology the data service provider employs. According to one embodiment, an end user can purchase a mobile computing device. Such purchases can take place in many ways, including, for example, over the internet, at a real world store, online store, and can include purchases that take time to be delivered to the end user. Conventionally such systems are preconfigured to communicate with a specific provider using communication hardware configured and compatible with the provider's signaling technology (e.g., a CDMA communication card is factory installed). Various methods discussed in greater detail herein, enable after distribution configuration of a softmodem to communicate using a variety of signaling technologies, and further provide for activation with an associated provider.

According to one aspect, a method for activating a mobile computing device after distribution is provided. The method comprises determining, by a processor state information for a communication subsystem on the mobile device; acquiring, by the processor, configuration data for the communication subsystem, responsive to user selection of a data service provider, wherein the configuration data includes information for an associated data provider communication protocol; and configuring, by the processor, the communication subsystem to communicate using the communication protocol.

In one embodiment, acquiring the configuration data for communication subsystem includes downloading firmware defining the associated data provider communicate protocol for the communication subsystem. In one embodiment, configuring the communication subsystem includes installing the downloaded firmware to configure the communication subsystem. In one embodiment, the method further comprises the an act of displaying on the mobile communication device a user interface configured to accept the user's selection of the data provider from a plurality of data providers associated with a plurality of communication protocols.

In one embodiment, the configuration data includes account information for the data service provider and device specific identifying information, and wherein the act of configuring includes establishing communication with the data service provider using the configuration data. In one embodiment, the method further comprises detecting an insertion of a Subscriber Identity Module (SIM) card. In one embodiment, the method further comprises displaying on the mobile communication device a user interface configured to accept the user's selection of the data provider responsive to the detected insertion of the SIM card.

In one embodiment, the method further comprises an act of re-configuring the communication subsystem from one data provider to another data provider. In one embodiment, re-configuring the communication subsystem includes re-configuring the communication sub-system from a first communication protocol associated with the one data provider to a second communication protocol associated with the another data provider.

According to one aspect, a system for activating a mobile computing device after distribution is provided. The system comprises at least one processor operatively connected to a memory, the at least one processor when executing is configured to determine state information for a communication subsystem on the mobile device; acquire configuration data for the communication subsystem, responsive to user selection of a data service provider, wherein the configuration data includes information for an associated data provider communication protocol; and configure the communication subsystem to communicate using the communication protocol.

In one embodiment, the system further comprises a communication subsystem configured to communicate over a plurality of communication protocols responsive to specification of firmware installed for the communication subsystem. In one embodiment, the at least one processor is configured to download firmware associated with the associated data service provider communication protocol. In one embodiment, configuring the communication subsystem includes installing the downloaded firmware. In one embodiment, the at least one processor is further configured to display on the mobile communication device a user interface configured to accept the user's selection of the data provider. In one embodiment, the at least one processor is further configured to determine a communication protocol associated with the selected data provider.

In one embodiment, the configuration data includes account information for the data service provider and device specific identifying information, and the at least one processor is further configured to establish communication on the communication subsystem with the data service provider using the configuration data. In one embodiment, the at least one processor is configured to detect an insertion of a Subscriber Identity Module (SIM) card. In one embodiment, the at least one processor is configured to display on the mobile communication device a user interface configured to accept the user's selection of the data provider responsive to the detected insertion of the SIM card.

In one embodiment, the at least one processor is configured to re-configure the communication subsystem from one data provider to another data provider. In one embodiment, the at least one processor is configured to re-configure the communication sub-system from a first communication protocol associated with the one data provider to a second communication protocol associated with the another data provider.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is an example block diagram of an activation engine, according to one embodiment;

FIG. 2 is an example process flow for post distribution activation of a mobile device, according to one embodiment;

FIG. 3 is a block diagram of a computer system on which various aspects disclosed herein can be practiced;

FIG. 4 is an example block diagram of an activation system, according to one embodiment; and

FIG. 5 is an example flow and interaction diagram, according to one embodiment.

### DETAILED DESCRIPTION

Stated broadly various aspects herein are directed to methods and systems for post distribution configuration and/or activation of communication hardware in mobile computing devices. According to one embodiment, provided is an activation engine executing on a mobile computing device. The activation engine can be configured to execute independently of other processes executing on a given computing device. In some embodiments, the activation engine can be incorporated within and/or called by other programs executing on, for example, a mobile computing device. The activation engine can be executed on a variety of computing platforms and is not limited to mobile devices. However, many advantages can be realized on mobile computing platforms. Traditionally, mobile computing devices and their associated hardware are tightly bound to a particular carrier or a data service provider, and more particularly the associated hardware in the device is specially configured to communicate on a specific provider's network.

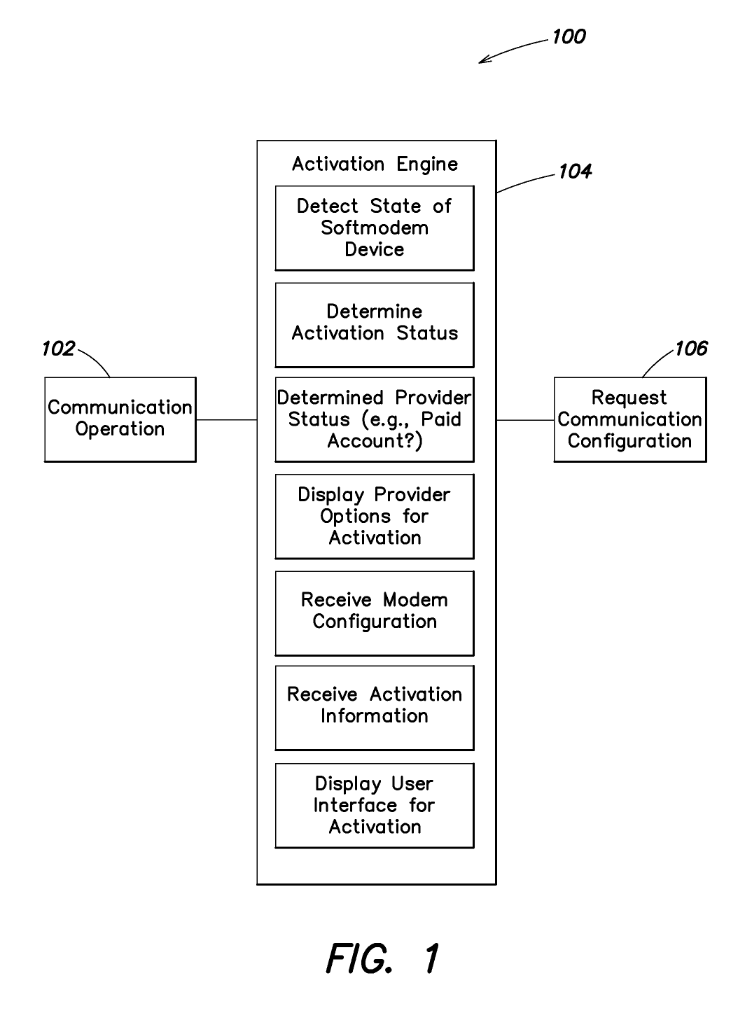

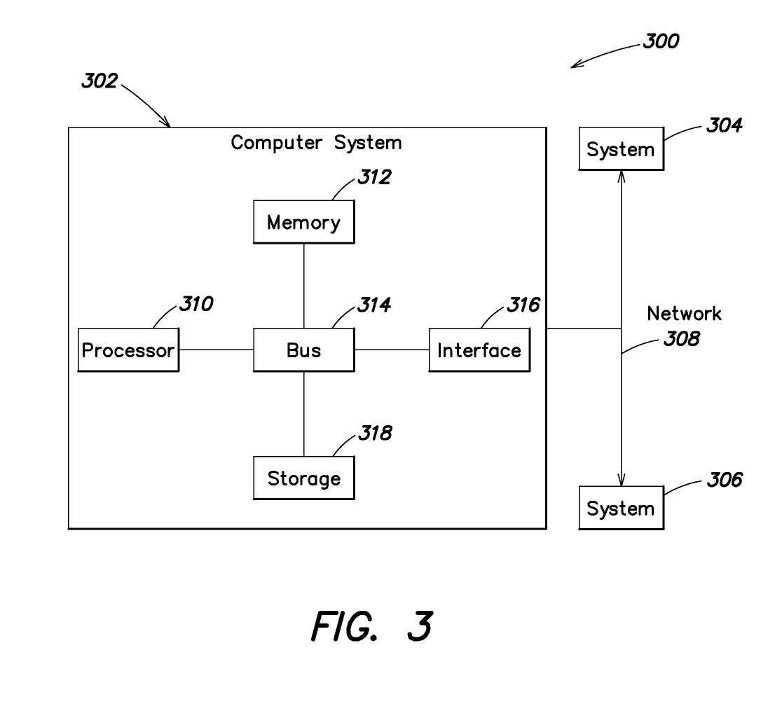

According to some embodiments, an activation engine, shown by way of example in FIG. 1, is configured to enable after distribution configuration and activation of communication hardware within a computing device. Shown in FIG. 1 is an activation engine system 100 that is executed on one or more processors of, for example, a computer system 300 or 302 as shown in FIG. 3 (discussed in greater detail below). Activation engine 104 can be executing on system 100 to provide one or more of the functions discussed herein. The activation engine can be configured to detect whether or not a modem device on the computer system has been activated for communication with a specific provider. The activation engine can also be configured to check a state of the modem at start up, at a first start up, and/or periodically during operation of the computing device.

In some embodiments, the activation engine 104 can also be configured to check the modem's activation status upon a communication request initiated by the device (e.g., at 102). In addition to determining the activation status and/or state of the softmodem device, the activation engine 104 can also communicate with provider networks to determine whether the end-user and/or device has an active or paid up data service account. For un-activated devices without paid accounts, the activation engine can be configured to initiate an interactive session for selecting a provider according to the end-user's preferences.

In some embodiments, the activation engine 104 can be configured to establish communication with, for example, an ecommerce site that provides an interface to a plurality of data service providers. The interactive session can include selecting a country for available providers and listing selectable providers according to the input country. The activation engine can be configured to accept payment information from the end-user and communicate the payment information, for example, to the ecommerce site. In response, the site may communicate activation codes for configuring the softmodem to transmit and receive in the cellular band with the selected provider. In one example, a licensing activation code (LAC) is communicated to identify the end-user, end-user device, and/or end-user account with the data service provider. In some embodiments, the LAC can be used in conjunction with device specific information (e.g., IMEI, IMSI, and Hardware ID, etc.) to configure the device and the softmodem for communication with a specific data service provider.

According to some embodiments, the activation engine 104 can be configured to validate information with a data service provider prior to configuring the softmodem for communication with a selected provider and/or an associated communication protocol. As discussed, the activation engine can also be configured to allow an end-user to select from a variety of different service providers regardless of the signaling technology used by the plurality of data service providers. For example, a service provider can implement a CDMA network, which typically requires a device configured for CDMA communication prior to delivery and/or shipping of a computing device to an end-user. In the United States, for example, different providers have different communication networks, implementing different communication protocols (e.g., CDMA, GSM, etc.). The hardware configuration on a given computing device often limits the choice of a data provider to those providers that are compatible with any installed communication devices.

According to one embodiment, the activation engine 104 enables post distribution activation and/or configuration of a softmodem compatible with a selected data service provider and associated communication protocol. Post delivery/shipment activation can occur as the result of an attempt by a computing device requesting data. The activation engine can be configured to initiate activation and/or configuration protocols responsive to data access attempts. For example, when the device is not connected to any communication networks, the computing device can be configured to attempt to communicate using the modem. If the modem has not been activated, the activation engine can be configured to start an activation session with the user of the device. According to some embodiments, the activation engine can be configured to display activation information for modems that are determined to be currently active.

For modems that are not active, the activation engine can be configured to establish a communication session using other communication hardware, for example, a wireless network card (e.g., a NIC) available on the computing device. In some embodiments, the softmodem can have a wireless connectivity configuration. The wireless connectivity configuration can be enabled, for example, as a default setting that permits activation and configuration of the softmodem as a cellular communication device, by first using an internet connection provided by the wireless connectivity configuration. In some embodiments, wireless connectivity can include known protocols (e.g., 802.11) for signaling to other devices. In particular, signaling can occur to other wireless devices in the end-user's home, including, for example, a router can provide an internet connection through the wireless connectivity setting for the softmodem. Cellular communication configuration data for the softmodem can be communicated over a computer network, including for example, the Internet. The configuration data can include firmware and/or software to configure the softmodem for cellular signaling protocols.

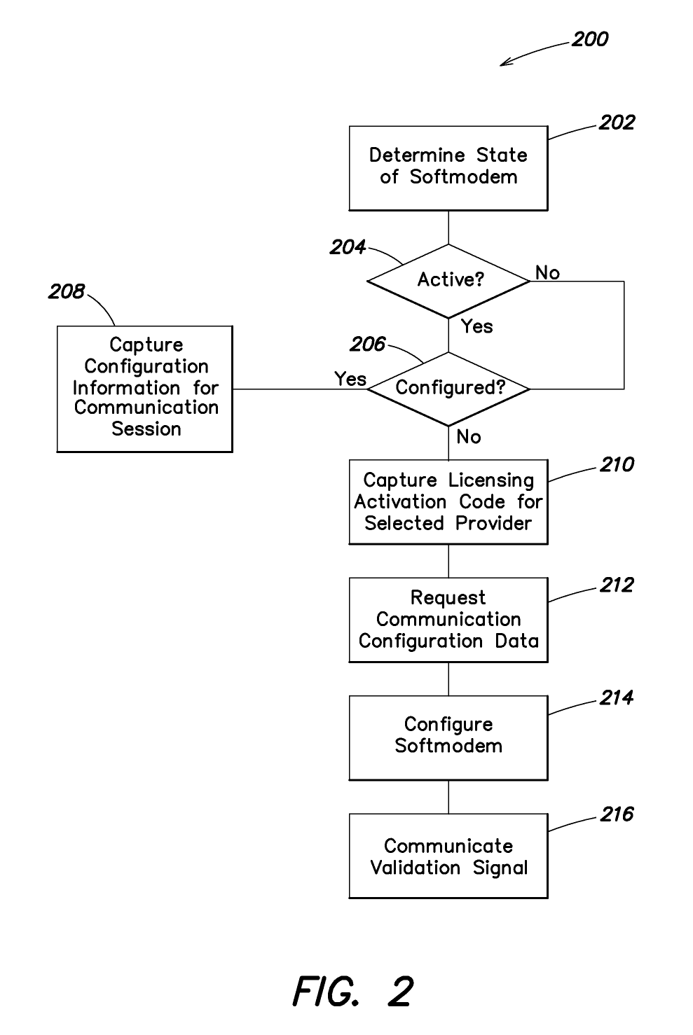

As discussed above, methods and systems for post distribution configuration and/or activation of communication hardware in mobile computing devices are provided. In some embodiments, activation systems can include an executing activation engine configured to execute processes for configuring a softmodem for communication with a selected data provider. In some embodiments, activation systems can execute such processes directly. FIG. 2 illustrates an example process flow for activating a softmodem for communication with a data provider after distribution of a device containing the softmodem.

Process 200 begins at 202 with a determination of the current state of the softmodem. If the modem is active 204 YES and the modem is configured 206 (YES) process 200 can end at 208 with accessing of the configuration information for the softmodem. In some embodiments, the configuration information can include any one or more of a LAC, IMEI, MSI, and hardware ID provided by configuration steps. The configuration data can also include activation keys used to activate the softmodem for communication with a specific provider. In some embodiments, the softmodem will only be active 204 YES and configured 206 YES, if the modem has been previously activated and configured.

In some settings, the softmodem is not active 204 NO and is also not configured 206 NO when the device containing the softmodem is initially delivered to an end user. For soft modems that are not activated and are not configured process 200 continues at 210 with receiving a LAC for a selected provider. In some embodiments, step 210 includes displaying a user interface to a user of the device having the softmodem. The user is able to select from a plurality of providers, for example, based on country, current location, etc. In some examples, the user is asked to provide payment information to subscribe with the selected provider. In response to processing payment information or a completed subscription/agreement a licensing activation code (LAC) can be communicated and stored on the device at 210.

In some embodiments, step 210 can include establishing communication with, for example, an ecommerce site that provides an interface to a plurality of data service providers. The communication session can include selecting a country for available providers and listing selectable providers according to the input country. As discussed, payment information may be required from the end-user. In response, the ecommerce site may communicate activation codes for configuring the softmodem to transmit and receive in the cellular band with the selected provider. In one example, a licensing activation code (LAC) is communicated to identify the end-user, end-user device, and/or end-user account with the data service provider. In some embodiments, the LAC can be used in conjunction with device specific information (e.g., IMEI, IMSI, and Hardware ID, etc., accessed at 212) to configure the device and the softmodem for communication with a specific data service provider. Requested configuration data can include firmware required for the softmodem to enable the softmodem to communicate according to a signaling protocol, and can also include activation keys from an entitlement management system (EMS), which can be communicated to the device at 212.

At 214, the modem installs any required firmware activating the modem for the selected communication protocol. The other configuration data (e.g., IMEI, IMSI, hardware IDS, activation key from EMS) can be used to configure the specifics of the communication with the selected data providers. Once active, a validation signal can be sent and received by the softmodem at 216.

According to some embodiments, the process 200 can include additional operations, including, for example, validation of information with a data service provider prior to configuring the softmodem (e.g., at 214) for communication with a selected provider and/or an associated communication protocol. As discussed, the user can select from a variety of different service providers at 210 regardless of the signaling technology used by the plurality of data service providers. For example, a service provider can implement a CDMA network, which typically requires a device configured for CDMA communication prior to delivery and/or shipping of a computing device to an end-user. In the United States, for example, different providers have different networks, implementing different communication protocols (e.g., CDMA, GSM, etc.). The hardware configuration on a given computing device often limits the choice of a data provider to those providers that are compatible with any installed communication devices.

In some further embodiments, process 200 can be executed to complete configurations for a failed configuration attempt. Additionally, process 200 can be executed to re-configure a softmodem. In one embodiment, a prior activation attempt may have failed, leaving the softmodem with some configuration data, but in an unactivated state 204 NO. Thus, the modem is partially configured, 206 NO, and an already acquired LAC can be accessed at 210. Firmware can be requested to configure the softmodem according to configuration settings for an already selected provider at 212. Configuration data on the device and the firmware received can then be used to configure the softmodem for communication at 214. As discussed, the configuration data can include any one or more of IMEI, IMSI, hardware ID, and activation keys (which may be requested from an EMS).

In one example, a configured softmodem can be re-configured for another data service provider, which can include configuring the softmodem for a different communication protocol. For example, at 210, a new LAC can be generated for the softmodem through selection of a new provider. New firmware can be requested and communicated at 212, enabling the softmodem to be changed from one signaling protocol to another (e.g., CDMA to GSM and vice-versa). Configuration data and firmware can be used to configure the modem at 214, and the new settings can be validated at 216. In another setting, process 200 or other similar functions, can also be used to release a communication configuration, in essence, reversing the assignment of configuration data for a softmodem.

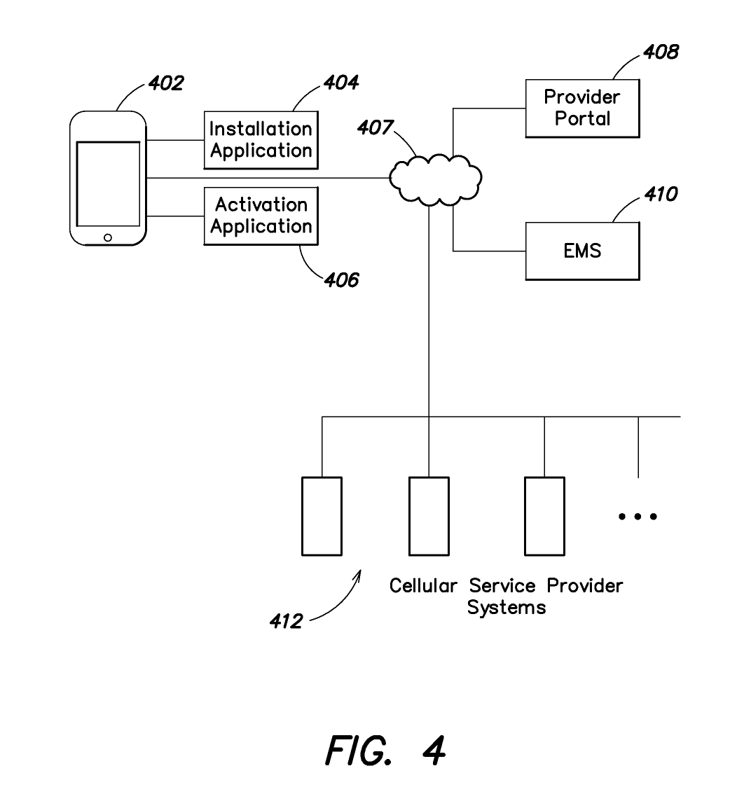

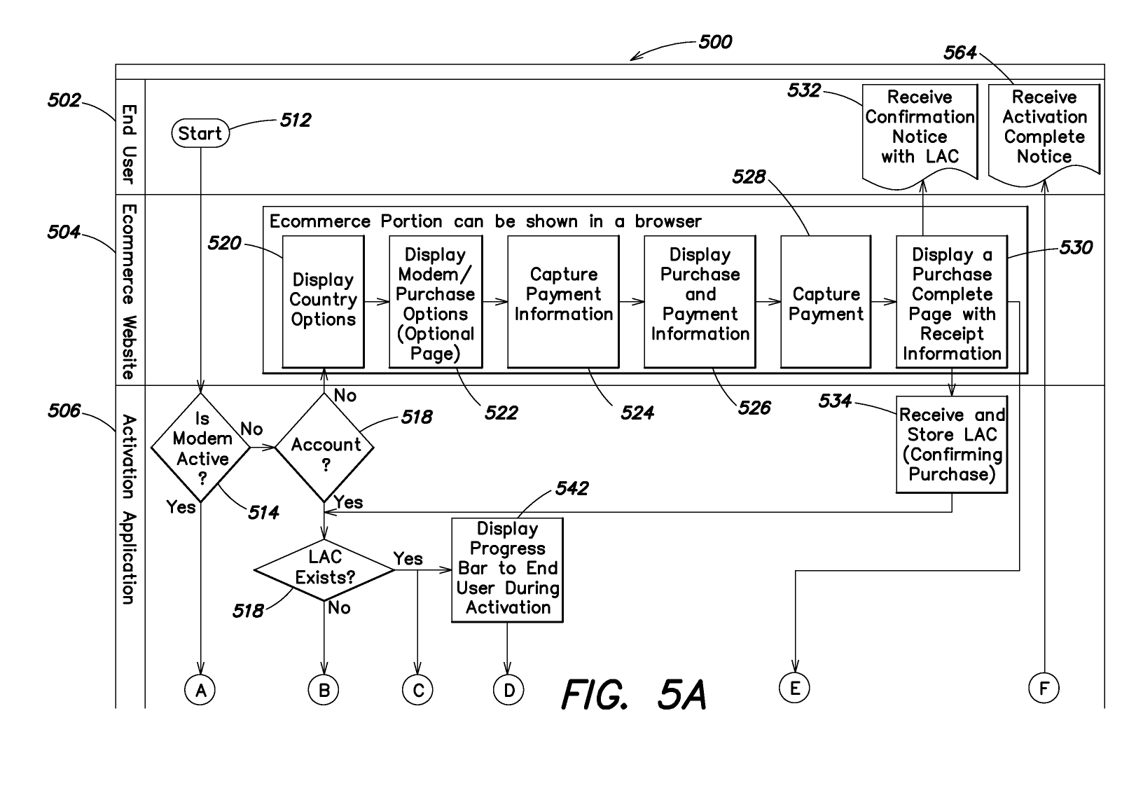

According to one embodiment, an installation application and/or an activation application can be executed on a computer system to configure an installed softmodem. Shown in FIG. 4 is a block diagram of an example architecture and system elements for an activation system. According to one embodiment, a computer system 402 can include an installation application 404 configured to interact with the softmodem and a SIM card currently installed or installed upon an activation attempt for the softmodem. An activation application 406 can also be installed on the computer system configured to interact with an operator of the computer device to activate the softmodem with a cellular provider. In some embodiments, the activation application can be a software application that executes in the foreground of the computer system 402. The activation application 406 can be configured to launch upon starting the computer system 402 or an attempt to use the softmodem. Further, the activation application can also be selected by the user for execution.

Once started the activation application 406 can be configured to communicate with a provider portal 408, for example, over a communication network 407. In one example, the communication network can be made accessible through an available home network of the operator of the computer system. According to one embodiment, the provider portal 408 is configured to provide an ecommerce portal to accessing data service options from available cellular service providers (e.g., at 412). The provider portal 408 can also be configured to manage purchase of services from the providers 412, including, for example, data service plans. The activation application 406 and the provider portal 408 can both communicate with an entitlement management system (“EMS”) 410 configured to provide an activation platform for configuring/activating communication with a data service provider (e.g., providers 412).

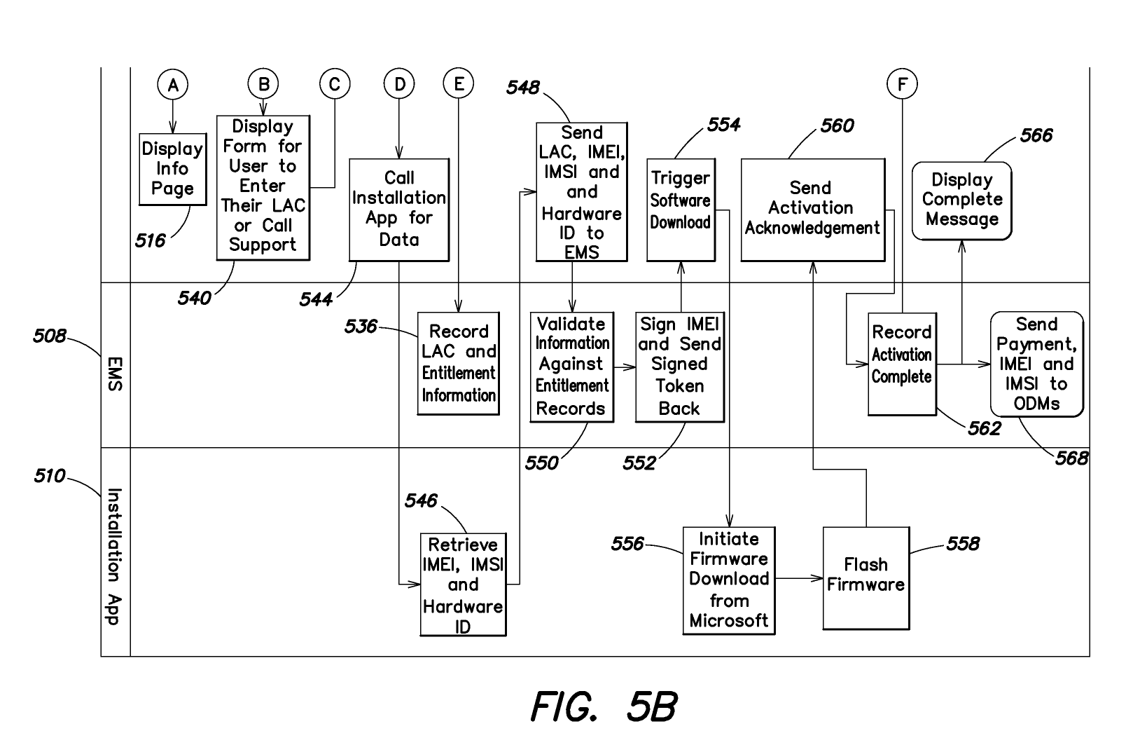

Shown in FIG. 5 is an example process flow and interaction diagram 500 describing additional detail of the interactions between elements identified in FIG. 4. In FIG. 5, an end user 502 operates a computer system having a softmodem. As discussed, the end user can trigger an activation application 506 configured to communicate with an ecommerce website 504 and EMS 508 to configure the softmodem according to hardware specific information provided by an installation application 510. In other embodiments, the operations of the installation application 510 and the activation application 506 can be combined into one or more other applications, functions, and/or computer executable entities. Further, in other embodiments, the operations and functions performed by the ecommerce site 504 and EMS 508 can also be combined.

As shown, the process flow of 500 begins at 512 with the end user triggering the activation application 506. In some examples, the end user can select the application to be executed. In others, the user can attempt to access data without a configured connection. In some embodiments, the user can also install a SIM card as part of 512. At 514, the activation application determined if the softmodem is active. If the softmodem is active 514 YES (i.e., configured to operate) then the process flow ends at 516 with a display on the end user's system having the smart modem showing a display indicating that the softmodem is configured for use. In one example, an information display is generated at 516 and shown to the end user 502 reflecting a data service provider, and any other additional details (including e.g., one or more of plan details, price, volume of data per time period to start running, connection strength, etc.).

If the softmodem is not activated, 514 NO, the activation application can be configured to determine if the computer device and/or softmodem is associated with an account for data service at 518. If an account is not set up, 518 NO, the activation application can be configured to trigger interaction with an ecommerce website 504. For example, the activation application 506 can execute and/or trigger a browser process on the computer system to access the ecommerce site 504. Once accessed the ecommerce site can be configured to provide options to the end user 502 for selecting a data provider. According to one embodiment, the website can display country or other options for refining selection of a data provider at 520. Modem/purchase options can be displayed at 522, for example, enabling selection of specific plans, which can include different data limits, different prices, etc. Payment information for subscribing or purchasing a data service plan can be captured at 524, and displayed at 526 with purchase detail information for confirmation. Payment can be executed at 528 and purchase confirmation page can be generated at 530 for display to the end user 502 at 532. Once the purchase is complete, the activation application 506 can receive and store a licensing activation code (LAC) confirming the purchase at 534. In addition, in response to receipt of the purchase information by the activation application, the ecommerce site is configured to deliver a purchase confirmation to EMS 508. The EMS 508 stores the purchase confirmation information (e.g., LAC and entitlement information) at 536.

Once the activation application stores the LAC, the process flow 500 continues with a check that the LAC exists at 538. The check is also triggered if account information is determined to exit at 518 YES. If the check does not pass 538 NO, the activation application can display a form to prompt the end user 502 enter their LAC at 540. The activation application 506 can also provide information on reaching customer assistance (e.g., to retrieve a lost LAC, diagnose issues with the user's computer system, etc.).

If the check is passed 538 YES, process 500 can continue, for example, with an optional display of a progress bar delivered to the end user 502 at 542. At 544, a call for hardware information is executed. In one example, the activation application 506 executes a call on the installation application 510 to retrieve device specific information. At 546, the installation application 510 communicates any one or more of IMEI, IMSI, and a Hardware ID for the end-user's computer system. Once the device specific information is retrieved, the activation application 506 communicates the device specific information and purchase confirmation information (e.g., LAC, IMEI, IMSI, and hardware ID) to the EMS at 548. The purchase and device specific information is validated at 550, for example, by the EMS 508.

According to one embodiment, the device specific information is signed and a signed token is communicated back to the activation application at 552. In response to receiving the signed token, the activation application 506 downloads software at 554 and the installation application 510 downloads the firmware for configuring the softmodem at 556. The softmodem's firmware is flashed at 558 and an activation acknowledgement is triggered at 560. At 562, the EMS records that the activation for the device is complete. The end user can receive a notification regarding the completion at 564, for example, based on the activation application triggering a display at 566. In some embodiments, the EMS 508 can also communicate the results of the activation process at 568 to any ODMs (Original Device Manufacturer) associated with the end user's device. For example, payment, IMEI and IMSI information can be communicated at 568 to the ODM for the end user's device. In other embodiments, the functions and flows described can be presented in different orders, and various functions and/or flows can be combined into fewer steps, for example, execution by fewer systems elements.

According to another embodiment, an activation system, activation engine, and/or activation application can implement any combination of the functions, features, and/or operations discussed. In one implementation, an activation application can be configured to provide any one or more of: capture of events raised by an Operating System (e.g., Windows 7, 8, Vista, Linux, etc.) in response to insertion of a SIM card in computing device, trigger a native application (e.g., activation engine, activation application, etc.) in response to the OS event, capture device/SIM specific information (e.g., an IMEI and IMSI) as event parameters to be used in subsequent processing, embed a browser process in the native application or trigger a browser process by the native application, process a payment transaction using the embedded “browser based” or triggered browser through an ecommerce site or application, detect the completion of the payment processing in the native application (e.g., receive confirmation notification), communicate with the ecommerce site and/or EMS systems to get a confirmation about the payment processing, make a registry entry and/or alternative storage mechanism with the relevant information, trigger the OS resident on the computing device so that firmware can be downloaded and installed for the softmodem according to a provider and signaling protocol (e.g., trigger a Windows Update process), and optionally reset the modem to inactive state (e.g., for demo purposes).

As discussed an activation system, activation engine, and/or activation application can implement a variety of functions to manage the configuration and activation of a softmodem. Example processes can be executed in whole or in part by the activation system, activation engine, and/or activation application to provide the functions. One example process flow includes a user opening their computing device (e.g., a tablet), execution of a check for status: (a) Modem is not activated yet and/or (b) No LAC exists, display an ecommerce portal page for selecting a provider: user selects the country; user selects a service plan, user enters credit card, user confirms the payment and any terms and conditions associated with the provider/service plan, ecommerce finishes payment processing with user supplied information, a LAC is stored on the user's computing device (e.g., tablet), status information is displayed (e.g., “Download-Installation in Progress . . . ”) during background execution of: retrieve IMEI, IMSI, and hardware ID from Installation App, retrieve activation key from EMS, download firmware (e.g., from Microsoft Update server), install the firmware, activates the modem, and send activation acknowledgement message to EMS, once finished display “Thank-you” message and optionally modem activation information.

Other processes can also be implemented, including for example a resume activation process for failed, interrupted or incomplete activations. According to one embodiment, a user opens their computing device (e.g., tablet), and activation application can start and check for status: a. Modem is not activated yet; b. LAC exists, and display “Download-Installation in Progress . . . ” message, during which the application performs the following in the background: retrieve IMEI, IMSI, and hardware ID (e.g., from an installation App), retrieve activation key from EMS, downloads firmware (e.g., from Microsoft Update server), installs the firmware, activates the modem, and send activation acknowledgement message to EMS. Once complete the application can display a confirmation message (e.g., “Thank-you” and optionally including modem information).

In another example, a process to refresh the device can be executed to remove configurations from the softmodem, to return the softmodem to factory settings or a default configuration to enable the user to re-select a provider and/or configuration for the softmodem. In one example execution, the refresh process includes checking the softmodem for status: (a) Modem has been activated and (b) LAC exists, displaying a modem information screen with a “Refresh” button or “Factory Reset” button display. In response to selection, firmware from the original modem installation can be re-installed and any LAC and/or activation keys associated with a prior activation can be cleared from the softmodem's settings. In some embodiments, after refresh or factory reset, an ecommerce portal page can be displayed to enable a user to reconfigure and/or re-activate their softmodem.

According to another aspect, other elements of the system can provide information on softmodem activations and/or configurations. For example, the EMS system can provide a user accessible web portal to allow administrative users to access information on softmodem activations and/or selected configurations. In some embodiments, an activation transaction report can be provided detailing a list of activation transactions.

Various aspects and functions described herein, in accord with aspects of the present invention, may be implemented as hardware, software, or a combination of hardware and software on one or more computer systems. There are many examples of computer systems currently in use. Some examples include, among others, network appliances, personal computers, tablets, phones, smart phones, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among one or more computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the implementation is not limited to any particular distributed architecture, network, or communication protocol. Furthermore, aspects in accord with the present invention may be implemented as specially-programmed hardware and/or software.

FIG. 3 shows a block diagram of a distributed computer system 300, in which various aspects and functions in accord with the present invention may be practiced. The distributed computer system 300 may include one or more computer systems. For example, as illustrated, the distributed computer system 300 includes three computer systems 302, 304 and 306. As shown, the computer systems 302, 304 and 306 are interconnected by, and may exchange data through, a communication network 308. The network 308 may include any communication network through which computer systems may exchange data. To exchange data via the network 308, the computer systems 302, 304 and 306 and the network 308 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA HOP, RMI, DCOM and Web Services.

Computer systems 302, 304 and 306 may include mobile devices such as cellular telephones. Various functions and processes discussed herein, can be implemented as applications executing on such mobile devices including smart phone. Mobile devices with cellular signaling hardware may communicate over a communication network that employs any one or more mobile access technologies including 2nd (2G), 3rd (3G), 4th (4G or LTE) generation radio access for cellular systems, WLAN, Wireless Router (WR) mesh, and other communication technologies. Access technologies such as 2G, 3G, 4G and LTE and future access networks may enable wide area coverage for mobile devices. For example, the network may enable a radio connection through a radio network access such as Global System for Mobil communication (GSM), General Packet Radio Services (GPRS), Enhanced Data GSM Environment (EDGE), Wideband Code Division Multiple Access (WCDMA), among other communication standards. Network may include any wireless communication mechanism by which information may travel between the devices and other computing devices in the network.

To ensure data transfer is secure, the computer systems 302, 304 and 306 may transmit data via the network 308 using a variety of security measures including TSL, SSL or VPN, among other security techniques. While the distributed computer system 300 illustrates three networked computer systems, the distributed computer system 300 may include any number of computer systems, networked using any medium and communication protocol.

Various aspects and functions in accord with the present invention may be implemented as specialized hardware or software executing in one or more computer systems including the computer system 302 shown in FIG. 3. As depicted, the computer system 302 includes a processor 310, a memory 312, a bus 314, an interface 316 and a storage system 318. The processor 310, which may include one or more microprocessors or other types of controllers, can perform a series of instructions that manipulate data. The processor 310 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 310 is connected to other system placements, including a memory 312, by the bus 314.

The memory 312 may be used for storing programs and data during operation of the computer system 302. Thus, the memory 312 may be a relatively high performance, volatile, random access memory such as a dynamic random access memory (DRAM) or static memory (SRAM). However, the memory 312 may include any device for storing data, such as a disk drive or other non-volatile storage device, such as flash memory or phase-change memory (PCM). Various embodiments in accord with the present invention can organize the memory 312 into particularized and, in some cases, unique structures to perform the aspects and functions disclosed herein.

Components of the computer system 302 may be coupled by an interconnection element such as the bus 314. The bus 314 may include one or more physical busses (for example, busses between components that are integrated within a same machine), and may include any communication coupling between system placements including specialized or standard computing bus technologies such as IDE, SCSI, PCI and InfiniB and. Thus, the bus 314 enables communications (for example, data and instructions) to be exchanged between system components of the computer system 302.

Computer system 302 also includes one or more interface devices 316 such as input devices, output devices and combination input/output devices. The interface devices 316 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 316 allow the computer system 302 to exchange information and communicate with external entities, such as users and other systems.

Storage system 318 may include a computer-readable and computer-writeable nonvolatile storage medium in which instructions are stored that define a program to be executed by the processor. The storage system 318 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 310 or some other controller may cause data to be read from the nonvolatile recording medium into another memory, such as the memory 312, that allows for faster access to the information by the processor 310 than does the storage medium included in the storage system 318. The memory may be located in the storage system 318 or in the memory 312. The processor 310 may manipulate the data within the memory 312, and then copy the data to the medium associated with the storage system 318 after processing is completed. A variety of components may manage data movement between the medium and the memory 312, and the invention is not limited thereto.

Further, the invention is not limited to a particular memory system or storage system. Although the computer system 302 is shown by way of example as one type of computer system upon which various aspects and functions in accord with the present invention may be practiced, aspects of the invention are not limited to being implemented on the computer system, shown in FIG. 3. Various aspects and functions in accord with the present invention may be practiced on one or more computers having different architectures or components than that shown in FIG. 3. For instance, the computer system 302 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 302 may include an operating system that manages at least a portion of the hardware placements included in computer system 302. A processor or controller, such as processor 310, may execute an operating system which may be, among others, a Windows-based operating system (for example, Windows NT, Windows 2000/ME, Windows XP, Windows 7, Windows 8, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for activating a mobile computing device after distribution, the method comprising:
determining, by a processor state information for a communication subsystem on the mobile device;
acquiring, by the processor, configuration data for the communication subsystem, responsive to user selection of a data service provider, wherein the configuration data includes information for an associated data provider communication protocol; and
configuring, by the processor, the communication subsystem to communicate using the communication protocol.

2. The method according to claim 1, wherein acquiring the configuration data for communication subsystem includes downloading firmware defining the associated data provider communicate protocol for the communication subsystem.

3. The method according to claim 2, wherein configuring the communication subsystem includes installing the downloaded firmware to configure the communication subsystem.

4. The method according to claim 1, further comprising an act of displaying on the mobile communication device a user interface configured to accept the user's selection of the data provider from a plurality of data providers associated with a plurality of communication protocols.

5. The method according to claim 1, wherein the configuration data includes account information for the data service provider and device specific identifying information, and wherein the act of configuring includes establishing communication with the data service provider using the configuration data.

6. The method according to claim 1, further comprising detecting an insertion of a Subscriber Identity Module (SIM) card.

7. The method according to claim 4, further comprising displaying on the mobile communication device a user interface configured to accept the user's selection of the data provider responsive to the detected insertion of the SIM card.

8. The method according to claim 1, further comprising an act of re-configuring the communication subsystem from one data provider to another data provider.

9. The method according to claim 8, wherein re-configuring the communication subsystem includes re-configuring the communication sub-system from a first communication protocol associated with the one data provider to a second communication protocol associated with the another data provider.

10. A system for activating a mobile computing device after distribution, the system comprising at least one processor operatively connected to a memory, the at least one processor when executing is configured to:
determine state information for a communication subsystem on the mobile device;
acquire configuration data for the communication subsystem, responsive to user selection of a data service provider, wherein the configuration data includes information for an associated data provider communication protocol; and
configure the communication subsystem to communicate using the communication protocol.

11. The system method according to claim 10, further comprising a communication subsystem configured to communicate over a plurality of communication protocols responsive to specification of firmware installed for the communication subsystem.

12. The system method according to claim 11, wherein the at least one processor is configured to download firmware associated with the associated data service provider communication protocol.

13. The system according to claim 12, wherein configuring the communication subsystem includes installing the downloaded firmware.

14. The system according to claim 10, wherein the at least one processor is further configured to display on the mobile communication device a user interface configured to accept the user's selection of the data provider.

15. The system according to claim 14, wherein the at least one processor is further configured to determine a communication protocol associated with the selected data provider.

16. The system according to claim 10, wherein the configuration data includes account information for the data service provider and device specific identifying information, and wherein the at least one processor is further configured to establish communication on the communication subsystem with the data service provider using the configuration data.

17. The system according to claim 10, wherein the at least one processor is configured to detect an insertion of a Subscriber Identity Module (SIM) card.

18. The system according to claim 17, wherein the at least one processor is configured to display on the mobile communication device a user interface configured to accept the user's selection of the data provider responsive to the detected insertion of the SIM card.

19. The system according to claim 10, wherein the at least one processor is configured to re-configure the communication subsystem from one data provider to another data provider.

20. The system according to claim 19, wherein the at least one processor is configured to re-configure the communication sub-system from a first communication protocol associated with the one data provider to a second communication protocol associated with the another data provider.
